(19) United States
(12) Patent Application Publication
(10) Pub. No.: US 2010/0310844 A1
(43) Pub. Date: Dec. 9, 2010

(54) METHOD FOR COATING A MOLDED FOAM PART

(75) Inventors: Christof Möck, Mannheim (DE); Bernhard Vath, Mannheim (DE); Lars Koppelmann, Mannheim (DE)

Correspondence Address: CONNOLLY BOVE LODGE & HUTZ LLP, P.O. BOX 2207, WILMINGTON, DE, 19899, US

(73) Assignee: BASF SE, Ludwigshafen (DE)

(21) Appl. No.: 12/599,170

(22) PCT Filed: May 5, 2008
(86) PCT No.: PCT/EP08/55491

§ 371 Date: Nov. 6, 2009

(30) Foreign Application Priority Data
May 8, 2007 (EP) 07107726.7

(51) Int. Cl. B32B 5/18; B32B 37/10; B32B 27/08; E04C 2/10

(52) U.S. Cl. 428/215; 156/285; 428/319.3

(57) ABSTRACT

1. The invention relates to a process for the coating of a foam molding with a plastics foil, which comprises
a) arranging and securing the foam molding in a capsule, the plastics foil having been applied here between capsule wall and foam molding,
b) evacuating the air in the chamber between plastics foil and foam molding, and
c) thus pressing the plastics foil onto the foam molding and, during this pressing procedure, maintaining a vacuum below 30 mbar,

and also to foam moldings which are obtainable for the first time by this process, and to the use of the foam moldings.

The invention relates to a process for the coating of a foam molding with a plastics foil, which comprises
a) arranging and securing the foam molding in a capsule, the plastics foil having been applied here between capsule wall and foam molding,
b) evacuating the air in the chamber between plastics foil and foam molding, and
c) thus pressing the plastics foil onto the foam molding and, during this pressing procedure, maintaining a vacuum.

The invention further relates to coated foam moldings which are obtainable for the first time by this process, and to the use of the foam moldings.

The prior art has hitherto described only complicated saturation or impregnation processes (see U.S. Pat. No. 6,607,817 and DE 100 11 388) for the downstream surface treatment of foam moldings. In these processes, foam sheets are immersed for saturation in a solution of a hydrophobizer or oleophobizer, the excess liquid is moved under pressure in a roll mill and the foam sheet is finally dried.

In the case of foam moldings, very little or no alteration of shape, color, and surface is possible. Specific features of foam moldings which are often unsatisfactory are their appearance and their properties such as feel and weathering-resistance.

It was therefore an object of the present invention to find a process which permits downstream modification of the surface of foam moldings.

Surprisingly, it has now been found that the process mentioned at the outset has excellent suitability for downstream surface modification of foam moldings.

A comparable process for the coating of doors has been disclosed previously in WO 01/032400. However, WO 01/032400 does not reveal whether, or how, foam moldings can be coated by said process.

The process described in WO 01/032400 is expressly incorporated herein by way of reference. In particular, explicit reference is made to the following process features and apparatus features of WO 01/032400, which are used individually or preferably in combination:
Infrared heating, which heats the plastics foil prior to pressure-application, preferably to from 120 to 180° C.—thus permitting avoidance of blistering, tearing of the foil or stress-whitening of the foil at angled regions.
Separate chambers between foam molding and foil (chamber A), and also between foil and capsule wall (chamber B)—a vacuum being applied advantageously to the chambers A and B simultaneously or preferably in succession. The vacuum is generally adjusted to below 50 mbar or preferably below 30 mbar. Buckling of the foil, or premature contact of the foil with the foam molding is thus inhibited. The foil is pressed onto the foam molding by reverting from the vacuum to atmospheric pressure in chamber B, while the vacuum in chamber A is still maintained.
Simultaneous coating of the foam molding with foil on opposing sides—this being achieved most simply by anchoring the foam molding in a frame composed of wood, metal or plastic, and keeping it centered in the middle of the coating chamber by virtue of a holder at the top ends of the frame. A further foil is introduced below the foam molding, thus producing a third chamber C between said foil and the lower capsule wall. A vacuum is then applied, as described at an earlier stage above, to all three of the chambers, and the foam molding is correspondingly double-side coated after heating of the foil by opening of the chambers A and C.
Coating of the plastics foil or preferably of the foam molding with an adhesive which permits long lasting adhesion of the foil to the foam molding.

Surprisingly, the inventive process is suitable for the coating of semi rigid foams and in particular of flexible foams, which were not hitherto accessible to coating with plastics foil. For the purposes of the invention, foams are foams to DIN 7726. For the purposes of this invention, elastic foams are foams to DIN 7726 which after brief deformation by 50% of their thickness by a method based on DIN 53 577 have, after 10 minutes, no residual deformation exceeding 2% of their initial thickness. The foam involved here can be flexible and elastic or semi rigid and elastic. A semi rigid elastic foam is an elastic foam to DIN 7726 whose compressive stress at 10% compression is greater than 15 kPa and smaller than 80 kPa, measured to DIN 53421/DIN EN ISO 604. A flexible elastic foam is an elastic foam to DIN 7726 whose compressive stress at 10% compression is 15 kPa, measured to DIN 53421/DIN EN ISO 604.

In order to avoid deformation of the foam molding during the coating process, the molding is clamped into an auxiliary frame during the entire process. To the extent that the frame is intended to remain in the finished coated foam molding, it is sprayed prior to the coating process with an appropriate adhesive which then in the coating process is activated by the heat of the foil. If the intention is to remove the frame after the coating process, no adhesive is applied, and the foil is preferably cut away by a blade along the frame.

Adhesives used preferably comprise aqueous systems based on polyurethane. Single-component systems can be used, as also can two-component systems.

PU dispersions can be used as single-component adhesives, and an example that may be mentioned here is Jowapur® 150.50. Combinations of PU dispersions, such as Jowapur® 150.30 with isocyanates, such as Jowat® 195.40, can be used as two-component adhesives. However, adhesives based on acrylate or on epoxy resin are also generally suitable for use here.

A two-layer foil with an adhesion promoter based on styrene-butadiene-styrene copolymers on the underside is likewise suitable. When the adhesive foils are used, it is generally possible to omit any use of an additional adhesive.

The adhesive can be applied by the conventional methods such as spreading, roller-application or spraying, and the spraying process is particularly preferred here. A drying time of 20 minutes at room temperature following application of the adhesive is sufficient for the systems described.

Examples of foams that are suitable for production of the inventive foam moldings are polyurethanes such as Elastopor® or Elastoflex® from Elastogran GmbH, polystyrene foams, such as Styropor®, Neopor®, or Styrodur® from BASF SE, polypropylene foams such as Neopolen® from BASF SE and melamine-formaldehyde-resin foams (abbreviated to melamine-resin foams with trademark Basotect®) from BASF SE. Particular preference is given to melamine-resin foams. The flexible foams here are generally open-cell foams. The sizes of the foam moldings are generally from DIN A4 to door size. The length of the foam sheets can be up to 6 m and their usual thickness is from 50-2000 mm.

Open-cell foams composed of melamine-formaldehyde polycondensates have excellent sound-deadening capability and exceptional thermal insulation properties. Another feature of these foamed plastics is safety in the event of a fire, and high heat resistance. This attractive property profile is complemented by low density.

These open-cell foams composed of melamine-formaldehyde polycondensates, known by the abbreviated term melamine-resin foam are therefore used in the construction and transport industries with the objective of noise reduction and/or energy saving.

A particular result of the use in the transport industry, for example in automobile construction, in rail vehicles, and in ship building is that the melamine-resin foam comes into contact with liquids, for example in the form of lubricating oil, condensation water, or rainwater. Contamination with liquids is also possible in engine test rigs and machinery capsules in which the melamine-resin foam is used for noise reduction.

Because of the open-cell nature of the foam and the absorption behavior of the underlying material, the melamine resin, the foam can absorb large amounts of liquid. Direct contact with water saturates, the melamine-resin foam becomes saturated, an example here being a cleaning sponge. Absorption of water amounts to more than 90% by volume (% by volume). The same applies to contact with engine oil, although the amount absorbed here is somewhat smaller because the viscosity is higher. By way of example, oil absorption of about 80% by volume was found in direct contact with engine oil whose SAE viscosity class is 10 W.

Coating with a plastics foil can almost completely suppress absorption of liquid by the foam molding.

Furthermore, coating with plastics foils can give a decisive improvement in the weathering resistance and the feel of foam moldings.

Particularly suitable plastics foils are polyvinyl chloride, styrene copolymers, polypropylene, polyvinylidene fluoride, thermoplastic polyurethane (TPU) and polymethyl methacrylate (PMMA). Styrene copolymers such as SAN, AMSAN and in particular ASA, have proven particularly suitable for outdoor applications, because of their weathering resistance. In the case of the ASA copolymer, for example, the foil can have modification by from 0.5-30% by weight of a thermoplastic elastomer. Typical classes of thermoplastic elastomer that can be used are: TPE-O (thermoplastic elastomers based on olefin, predominantly PP/EPDM), TPE-V (crosslinked thermoplastic elastomers based on olefin, predominantly PP/EPDM), TPE-U (thermoplastic elastomers based on urethane), TPE-E (thermoplastic copolyesters), TPE-S (styrene block copolymers, e.g. SBS, SEBS, SEPS, SEEPS, MBS) and TPE-A (thermoplastic copolyamides, e.g. PEBA). These foils can be used not only in various plain colors but also with printed surfaces. The surface moreover can be structured by various embossing rolls during the extrusion of the foil.

The thickness of the foils used is from 50 to 750 μm, preferably from 100 to 500 μm and particularly preferably from 200 to 350 μm. They can be produced from pellets of the corresponding starting materials by the known processes for production of foils, and preference is given here to the extrusion process for east-film production.

To improve adhesive properties, the foils may have been subjected to a corona treatment either on one side or on two sides.

The coated foam moldings can be used with advantage in the construction sector, because of good thermal insulation and sound deadening, and sound attenuation.

The inventive moldings can in particular be used as ceiling cladding and wall cladding.

The low weight of the foam moldings and the ease in modifying their surface moreover give them very good suitability for construction of exhibition stands, for screen partitions, and for room dividers, and it is very easy to produce lightweight scenery.

The thermal-insulation performance of the inventive foam moldings, and their attractive surface and their high flexibility give them excellent suitability for the lamination of, for example, cable ducts, of roller-shutter casings and of curtain rail systems. The moldings can be adapted rapidly to the prevailing requirements, for example, by cutting, bending, etc., and have the flexibility to fit into the respective recess. This procedure is reversible and in many cases requires no additional holder.

Open-cell foams usually have excellent suitability for providing padding to, for example, seating, mattresses or mats. As described above, an appropriate plastics foil can provide an attractive exterior, an example being synthetic leather.

The padding can serve to increase safety in road traffic, for example, in the sector of pedestrian protection on vehicles. By way of example, front spoilers of vehicles can be equipped with the foam moldings.

Another possibility, however, is cladding of the walls of gymnasiums, and also of garages, parking lots, and center guard rails. At least at vehicle height, this addition to the wall can be used to avoid damage to the vehicle during, for example, parking.

### APPLICATION EXAMPLE

### Single-Side Coating of a Melamine-Resin Foam Sheet with an ASA Foil

The substrate used for single-side coating was a flexible foam molding composed of Basotect®, a commercially available melamine-formaldehyde resin foam from BASF SE. The length of the molding was 29 cm, its width was 21 cm and its height was 5 cm. The first operation began by applying the adhesive. The adhesive used comprised an aqueous two-component system (composed of binder and hardener) based on polyurethane, which was produced immediately prior to application by mixing of the two individual components. In order to obtain a homogeneous mixture, the mixture was stirred at room temperature for at least 3 min using a stirrer with precision glass gland. An amount of 80 g/m² of the adhesive was then applied with the aid of a Walther Pilot spray gun to one of the two surfaces of the molding. The molding was then allowed to dry for 20 minutes at room temperature. In the next step, the molding was placed into an appropriately sized wood frame (wall thickness 2 cm), which enclosed, with precise fit, the external edges of the molding. The molding fixed within the frame was then secured in the coating capsule, the plastics foil to be applied having been put in place between capsule wall and molding. That surface of the molding which had been sprayed with adhesive was facing toward the plastics foil here. The plastics foil used comprised a white-pigmented foil of thickness 250 μm composed of Luran® S, which is the ASA copolymer commercially available from BASF SE. The two separate chambers between foam molding and foil (chamber A) and between foil and capsule wall (chamber B) were then simultaneously evacuated in the capsule. Once a vacuum of 25 mbar had been achieved, the plastics foil was heated to a temperature of 150° C. with the aid of IR sources which had been put in place at the capsule wall above the foil (in chamber B). Once the temperature had been reached, the heating was terminated and chamber B was brought back to atmospheric pressure, using air, but at the same time the vacuum in chamber A was maintained. The flooding of chamber B produced an overpressure, and consequently the heated plastics foil was applied under pressure to that surface of the molding which had been sprayed with adhesive. This ended the coating process. Heating by the IR sources during the process moreover activated the adhesive at the surface of the molding, thus achieving very good adhesion between adhesive and plastics foil as soon as the process had ended. Once the coating procedure had concluded, the coated molding was removed from the capsule and the wood frame surrounding the external edges was removed. The foil protruding over the edges of the coated surface was removed manually, using a sharp blade.

1. A process for the coating of a foam molding with a plastics foil, which comprises
a) arranging and securing the foam molding in a capsule, the plastics foil having been applied here between capsule wall and foam molding,
b) evacuating the air in the chamber between plastics foil and foam molding, and
c) thus pressing the plastics foil onto the foam molding and, during this pressing procedure, maintaining a vacuum below 30 mbar.

2. The process according to claim 1, wherein, between plastics foil and capsule wall, a second chamber exists which initially likewise is evacuated below 30 mbar, and during steps b) and/or c), is brought back to atmospheric pressure in order to press the foil onto the foam molding.

3. The process according to claim I for the double-sided coating of a foam molding wherein the foam molding is placed between two plastics foils and, in steps b) and c), a vacuum is applied and maintained in the chamber delimited by the two foils.

4. The process according to claim 3, wherein, between the two plastics foils and the respective capsule wall, two further chambers exist which, during steps b) and/or c) are brought back to atmospheric pressure in order to press the foils onto the opposing sides of the foam molding.

5. The process according to any of claims 1 to 4, wherein, prior to step b), an adhesive is applied to the foam molding and/or the plastics foils.

6. The process according to any of claims 1 to 5, wherein the foam molding is composed of a polyurethane foam and/or melamine-resin foam.

7. The process according to claim 6, wherein the foam molding is, in step a), introduced into a frame in order to ensure uniform application of the foil to the foam molding in steps b) and c).

8. A single-sided coated foam molding obtainable by any of the processes of 1, 2 or 5 to 7.

9. A double-sided coated foam molding obtainable by any of the processes of 3 to 7.

10. The process according to any of claims 1 to 9, wherein the foils are base-coat foils which can easily be post-treated.

11. A coated foam molding according to claims 8 to 10, where the foil is composed of one or more plastics selected from the group consisting of polyvinyl chloride, styrene copolymers, polypropylene, polyvinylidene fluoride, thermoplastic polyurethane and polymethyl methacrylate, and its layer thickness is from 100-500 μm.

12. The coated foam molding according to claim 11 where the foil is composed of a fiber-reinforced plastic.

13. The coated foam molding according to claim 11 where the foil is composed of SAN, AMSAN or ASA.

14. The use of the foam moldings according to claims 8 to 13 for thermal insulation or sound deadening or for sound attenuation.

15. The use of the foam moldings according to claims 8 to 13 for ceiling cladding and wall cladding.

16. The use of the foam moldings according to claims 8 to 13 for screen partitions.

17. The use of the foam moldings according to claims 8 to 13 for the lamination of, for example, cable ducts, roller-shutter casings, and curtain rails.

18. The use of the foam moldings according to claims 8 to 13 for providing padding to, for example, seats, mattresses, mats, gymnasium walls, garages, parking lots or center guard rails.

19. The use of the foam moldings according to claims 8 to 13 in the sector of pedestrian protection on vehicles.
